(19) United States
(12) Patent Application Publication
(10) Pub. No.: US 2025/0232915 A1
(43) Pub. Date: Jul. 17, 2025

(54) CAPACITOR UNIT AND CAPACITOR

(71) Applicant: REALTEK SEMICONDUCTOR CORP., Hsinchu (TW)

(72) Inventors: Shih-Bin Chen, Hsinchu (TW); Kai-Yue Lin, Hsinchu (TW)

(73) Assignee: REALTEK SEMICONDUCTOR CORP., Hsinchu (TW)

(21) Appl. No.: 18/907,920

(22) Filed: Oct. 7, 2024

(30) Foreign Application Priority Data
Jan. 15, 2024 (TW) 113101604

(51) Int. Cl. H01G 4/01; H01G 4/228

(52) U.S. Cl. CPC H01G 4/01; H01G 4/228

(57) ABSTRACT

A capacitor unit includes a first finger electrode, a second finger electrode, and a third finger electrode. The first finger electrode points to the second finger electrode and the third finger electrode, and is configured to receive a first terminal signal. The second finger electrode points to the first finger electrode, and is configured to receive a second terminal signal. The third finger electrode is disposed adjacent to the second finger electrode with an interval. The third finger electrode points to the first finger electrode, and is configured to receive another second terminal signal. One part of the first finger electrode is disposed interleaved with the second finger electrode, and the other part of the first finger electrode is disposed interleaved with the third finger electrode.

### CROSS-REFERENCE TO RELATED APPLICATION

This non-provisional application claims priority under 35 U.S.C. § 119(a) to patent application No. 113101604 filed in Taiwan, R.O.C. on Jan. 15, 2024, the entire contents of which are hereby incorporated by reference.

### BACKGROUND

### Technical Field

The present invention relates to a semiconductor apparatus, and particularly relates to a capacitor unit capable of reducing a layout area, and a capacitor.

### Related Art

With downward size reduction and circuit density increase of an integrated circuit apparatus, it is increasingly important to manufacture a capacitor unit capable of maintaining equivalent capacitance and effectively reducing an occupied area. Currently, a metal-oxide-metal (MOM) capacitor is widely used in the industry due to an advantage of low capacitance leakage. Traditionally, a single MOM capacitor includes two finger electrodes that are interleaved. One of the two finger electrodes is configured as a positive terminal, and the other of the finger electrodes is configured as a negative terminal.

However, positive terminals and negative terminals of a plurality of MOM capacitors forming a capacitor are intended to receive different signals, and the ends are required to be arranged in an interleaving manner, the MOM capacitors cannot share some electrodes, and therefore intervals specified by a layout rule are required to be provided. This increases a layout area of the capacitor. In addition, there are many limitations on arrangement of the MOM capacitors.

### SUMMARY

In an embodiment, a capacitor unit includes a first finger electrode, a second finger electrode, and a third finger electrode. The first finger electrode is configured to receive a first terminal signal. The second finger electrode points to the first finger electrode, and is configured to receive a second terminal signal. The third finger electrode is disposed adjacent to the second finger electrode with an interval. The third finger electrode points to the first finger electrode, and is configured to receive another second terminal signal. The first finger electrode points to the second finger electrode and the third finger electrode. One part of the first finger electrode is disposed interleaved with the second finger electrode, and the other part of the first finger electrode is disposed interleaved with the third finger electrode.

In an embodiment, a capacitor includes a plurality of foregoing capacitor units. The capacitor units are disposed in sequence. Any two adjacent capacitor units in the capacitor units abut each other through respective second finger electrodes by sharing one second branch electrode section, or abut each other through respective third finger electrodes by sharing one third branch electrode section.

In summary, for the capacitor using the capacitor unit of any embodiment, a layout area of the capacitor can be reduced by sharing the second branch electrode section and/or sharing the third branch electrode section. In addition, a second terminal signal and another second terminal signal that are received by the capacitor using the capacitor unit of any embodiment may be arranged in an interleaving manner, to reduce mismatching effects.

The following describes, in detail in implementations, detailed features and advantages of the present invention, and the content is sufficient to enable any person skilled in the art to understand the technical content of the present invention for implementation accordingly. In addition, any person skilled in the art can easily understand related objectives and advantages of the present invention according to the content disclosed in this specification, the application scope, and the accompanying drawings.

### BRIEF DESCRIPTION OF THE DRAWINGS

FIG. 1 is a schematic diagram of a layout of an embodiment of a capacitor unit;

FIG. 2 is a schematic diagram of a circuit of an embodiment of a capacitor unit;

FIG. 3 is a schematic diagram of a layout of an embodiment of a capacitor unit;

FIG. 4 is a schematic diagram of a layout of an embodiment of a capacitor;

FIG. 5 is a schematic diagram of a layout of an embodiment of a capacitor;

FIG. 6 is a schematic diagram of a layout of a capacitor implemented by a conventional MOM capacitor; and

FIG. 7 is a histogram of a quantity of capacitor units and a layout area reduction rate.

### DETAILED DESCRIPTION

To make the objectives, features, and advantages of the embodiments of the present invention clearer and easier to understand, the following makes detailed descriptions with reference to the accompanying drawings.

It should be understood that the term “include” in this specification is used to indicate existence of a specific technical feature, value, method, step, operation process, element, and/or component, but does not exclude addition of more technical features, values, methods, steps, operation processes, elements, and components, or any combination thereof.

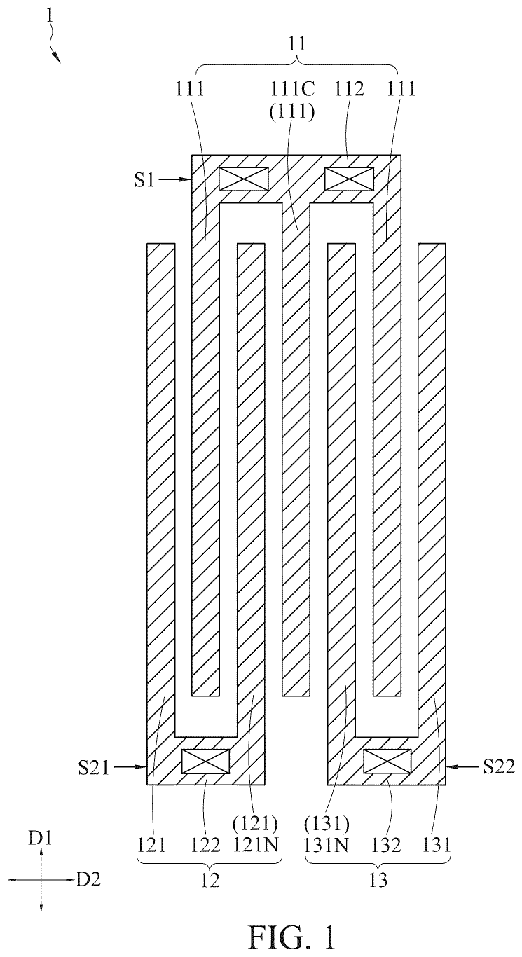

FIG. 1 is a schematic diagram of a layout of an embodiment of a capacitor unit 1. Refer to FIG. 1. The capacitor unit 1 includes a plurality of finger electrodes. Each finger electrode is comb-like. The following uses three finger electrodes (referred to hereinafter as a first finger electrode 11, a second finger electrode 12, and a third finger electrode 13, respectively) as an example. Here, the second finger electrode 12 and the third finger electrode 13 are disposed adjacent to each other with an interval. The first finger electrode 11 is disposed opposite to the second finger electrode 12 and the third finger electrode 13. Specifically, the first finger electrode 11 points to the second finger electrode 12 and the third finger electrode. The second finger electrode 12 and the third finger electrode 13 point to the first finger electrode 11, respectively. The first finger electrode 11 is disposed interleaved with the second finger electrode 12 and the third finger electrode 13 in sequence.

In some embodiments, the first finger electrode 11 points to, in a first direction D1, the second finger electrode 12 and the third finger electrode 13 that are disposed at an interval in a second direction D2. The second direction D2 is orthogonal to the first direction D1. The second finger electrode 12 and the third finger electrode 13 point to the first finger electrode 11 in the first direction D1. Here, the first finger electrode 11 may be disposed interleaved with the second finger electrode 12 and the third finger electrode 13 in sequence in the second direction D2. In other words, one part of the first finger electrode 11 may be disposed interleaved with the second finger electrode 12, and the other part of the first finger electrode 11 may be disposed interleaved with the third finger electrode 13. In some implementations, the first direction D1 is a Y-axis direction, and the second direction D2 is an X-axis direction.

In some embodiments, the first finger electrode 11 is configured to receive a first terminal signal S1. The second finger electrode 12 is configured to receive a second terminal signal S21. The third finger electrode 13 is configured to receive another second terminal signal S22.

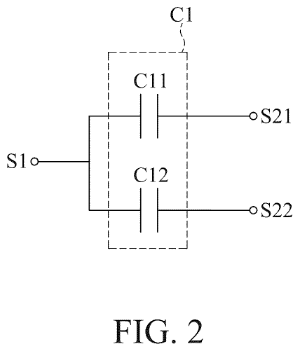

FIG. 2 is a schematic diagram of a circuit of an embodiment of the capacitor unit 1. Refer to FIG. 1 and FIG. 2. In some embodiments, the first terminal signal S1 received by the first finger electrode 11 and the second terminal signal S21 received by the second finger electrode 12 may form a first set of differential signals. The first terminal signal S1 received by the first finger electrode 11 and the second terminal signal S22 received by the third finger electrode 13 may form a second set of differential signals. Here, the first set of differential signals may form an equivalent capacitor C11 between the first finger electrode 11 and the second finger electrode 12, and the second set of differential signals may form an equivalent capacitor C12 between the first finger electrode 11 and the third finger electrode 13. In other words, one end of the equivalent capacitor C11 and one end of the equivalent capacitor C12 are configured to receive the same first terminal signal S1, and therefore may be connected to each other. The other end of the equivalent capacitor C11 receives the second terminal signal S21. The other end of the equivalent capacitor C12 receives the another second terminal signal S22. Here, the equivalent capacitor C11 and the equivalent capacitor C12 may be regarded as one equivalent capacitor C1 with three terminals. A first terminal of the equivalent capacitor C1 is configured to receive the first terminal signal S1. A second terminal of the equivalent capacitor C1 is configured to receive the second terminal signal S21. A third terminal of the equivalent capacitor C1 is configured to receive the another second terminal signal S22.

In some embodiments, the first terminal signal S1 may be a positive terminal input signal, and the second terminal signal S21 and the second terminal signal S22 are negative terminal input signals, respectively. In some implementations, the second terminal signal S21 and the second terminal signal S22 may be negative terminal input signals whose potentials are different from each other, respectively. In some other implementations, the second terminal signal S21 and the second terminal signal S22 may be negative terminal input signals whose potentials are the same. In some other embodiments, the first terminal signal S1 may be a negative terminal input signal, and the second terminal signal S21 and the second terminal signal S22 are positive terminal input signals, respectively. In some implementations, the second terminal signal S21 and the second terminal signal S22 may be positive terminal input signals with whose potentials are different from each other, respectively. In some other implementations, the second terminal signal S21 and the second terminal signal S22 may be positive terminal input signals whose potentials are the same.

Refer to FIG. 1. In some embodiments, each finger electrode includes a plurality of branch electrode sections extending in the first direction D1 and a trunk electrode section extending in the second direction D2. One end of each branch electrode section is coupled to the trunk electrode section. Therefore, a comb-like structure is formed.

Specifically, the first finger electrode 11 includes a plurality of first branch electrode sections 111 and a first trunk electrode section 112. The plurality of first branch electrode sections 111 are arranged at intervals in the second direction D2. Each first branch electrode section 111 extends in the first direction D1. The first trunk electrode section 112 extends in the second direction D2. One end (referred to hereinafter as a connection end) of each first branch electrode section 111 is connected to the first trunk electrode section 112. Therefore, the first branch electrode sections 111 and the first trunk electrode section 112 form a multi-finger pattern. Here, a U-shaped groove may be formed between any two adjacent first branch electrode sections 111 and the first trunk electrode section 112. The U-shaped groove is downwards opened.

The second finger electrode 12 includes a plurality of second branch electrode sections 121 and a second trunk electrode section 122. The plurality of second branch electrode sections 121 are arranged at intervals in the second direction D2, and are disposed interleaved with the plurality of first branch electrode sections 111. Each second branch electrode section 121 is disposed extending in the first direction D1. The second trunk electrode section 122 extends in the second direction D2. The second trunk electrode section 122 and the first trunk electrode section 112 are located on different extension lines. An extension line of the second trunk electrode section 122 is substantially parallel to that of the first trunk electrode section 112. One end (referred to hereinafter as a connection end) of each second branch electrode section 121 is connected to the second trunk electrode section 122. Therefore, the second branch electrode sections 121 and the second trunk electrode section 122 form a multi-finger pattern. In addition, the other end of each second branch electrode section 121 extends to be adjacent to the first trunk electrode section 112, keeping a gap with the first trunk electrode section 112. Here, a U-shaped groove may be formed between any two adjacent second branch electrode sections 121 and the second trunk electrode section 122. The U-shaped groove is upwards opened.

The third finger electrode 13 includes a plurality of third branch electrode sections 131 and a third trunk electrode section 132. Each third branch electrode section 131 extends in the first direction D1. The plurality of third branch electrode sections 131 are arranged at intervals in the second direction D2. A third branch electrode section 131N in the plurality of third branch electrode sections 131 is adjacent to and spaced from a second branch electrode section 121N in the plurality of second branch electrode sections 121. For example, when the third finger electrode 13 is disposed on the left of the second finger electrode 12, the second branch electrode section 121N and the third branch electrode section 131N that are adjacent to and spaced from each other are the rightmost second branch electrode section in the plurality of second branch electrode sections 121 and the leftmost third branch electrode section 131N in the plurality of third branch electrode sections 131. The third trunk electrode section 132 extends in the second direction D2. The third trunk electrode section 132 and the second trunk electrode section 122 are arranged at an interval on a same extension line.

One end (referred to hereinafter as a connection end) of each third branch electrode section 131 is connected to the third trunk electrode section 132. Therefore, the third branch electrode sections 131 and the third trunk electrode section 132 form a multi-finger pattern. In addition, the other end of each third branch electrode section 131 extends to be adjacent to the first trunk electrode section 112, keeping a gap with the first trunk electrode section 112. Here, a U-shaped groove may be formed between any two adjacent third branch electrode sections 131 and the third trunk electrode section 132. The U-shaped groove is upwards opened.

Here, one part of the first finger electrode 11 is coupled to the adjacent second finger electrode 12, and the other part of the first finger electrode 11 is coupled to the adjacent third finger electrode 13.

In some embodiments, the other end of each first branch electrode section 111 is a free end (that is, not connected to another electrode section), and is adjacent to the second trunk electrode section 122 or the third trunk electrode section 132 relative to the connection end of the first branch electrode section. The other end of each second branch electrode section 121 is a free end, and is adjacent to the first trunk electrode section 112 relative to the connection end of the second branch electrode section. The other end of each third branch electrode section 131 is a free end, and is adjacent to the first trunk electrode section 112 relative to the connection end of the third branch electrode section. In the plurality of first branch electrode sections 111 of the first finger electrode 11, one part of the first branch electrode sections 111 are located between adjacent second branch electrode sections 121 (that is, located in U-shaped grooves formed by the adjacent second branch electrode sections 121 and the second trunk electrode section 122), another part of first branch electrode sections 111 are located between adjacent third branch electrode sections 131 (that is, located in U-shaped grooves formed by the adjacent third branch electrode sections 131 and the third trunk electrode section 132), and the other first branch electrode sections 111 are located between the second branch electrode section 121N and the third branch electrode section 131N that are adjacent to each other (that is, located between the second finger electrode 12 and the third finger electrode 13). Therefore, the first finger electrode 11 is disposed between the second finger electrode 12 and the third finger electrode 13 in an interleaving manner. Here, only one first branch electrode section 111 is disposed between any two adjacent second branch electrode sections 121. Only one first branch electrode section 111 is disposed between any two adjacent third branch electrode sections 131. Only one first branch electrode section 111C is disposed between the second branch electrode section 121N and the third branch electrode section 131N that are adjacent to each other.

In some embodiments, a total quantity of the plurality of first branch electrode sections 111, the plurality of second branch electrode sections 121, and the third branch electrode sections 131 of the capacitor unit 1 may be odd, so that the capacitor unit 1 may be connected to another capacitor unit by sharing one branch electrode section. In addition, a total quantity of the plurality of first branch electrode sections 111 may be a total quantity of the plurality of second branch electrode sections 121 and the plurality of third branch electrode sections 131 minus 1.

For example, as shown in FIG. 1, in an implementation, the total quantity of the plurality of first branch electrode sections 111 may be 3, a total quantity of the second branch electrode sections 121 is 2, and a total quantity of the plurality of third branch electrode sections 131 is 2. Here, from left to right in the second direction D2, the 1^{st} first branch electrode section 111 is located between the 1^{st} second branch electrode section 121 and the 2^{nd} second branch electrode section 121N, the 2^{nd} first branch electrode section 111C is located between the 2^{nd} second branch electrode section 121N and the 1^{st} third branch electrode section 131N, and the 3^{rd} first branch electrode section 111 is located between the 1^{st} third branch electrode section 131N and the 2^{nd} third branch electrode section 131.

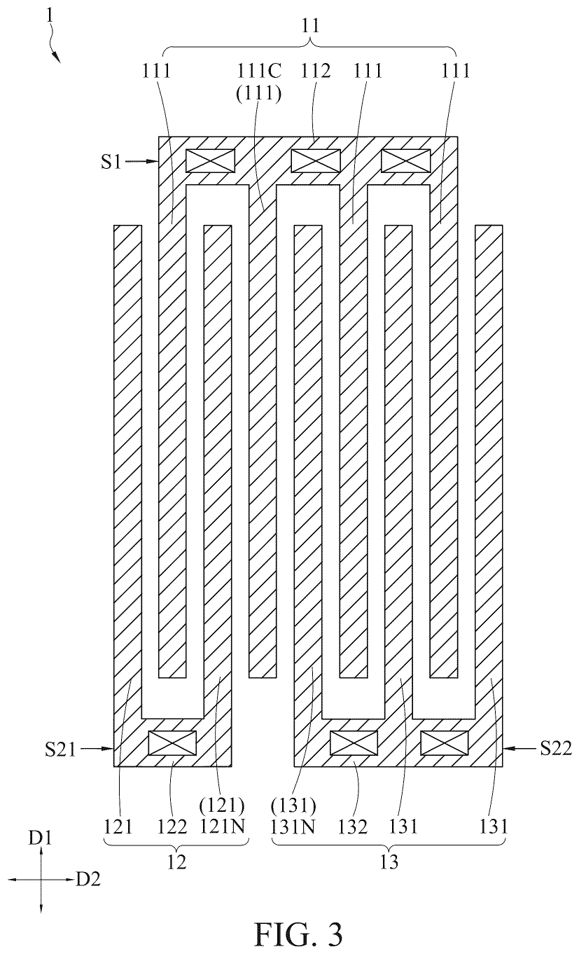

For another example, as shown in FIG. 3, in an implementation, the total quantity of the plurality of first branch electrode sections 111 may be 4, a total quantity of the second branch electrode sections 121 is 2, and a total quantity of the plurality of third branch electrode sections 131 is 3. Here, from left to right in the second direction D2, the 1^{st} first branch electrode section 111 is located between the 1^{st} second branch electrode section 121 and the 2^{nd} second branch electrode section 121N, the 2^{nd} first branch electrode section 111C is located between the 2^{nd} second branch electrode section 121N and the 1^{st} third branch electrode section 131N, the 3^{rd} first branch electrode section 111 is located between the 1st third branch electrode section 131N and the 2^{nd} third branch electrode section 131, and the 4th first branch electrode section 111 is located between the 2^{nd} third branch electrode section 131 and the 3^{rd} third branch electrode section 131.

In some embodiments, when the total quantity of the plurality of second branch electrode sections 121 is the same as that of the plurality of third branch electrode sections 131, for example, as shown in FIG. 1, the second finger electrode 12 and the third finger electrode 13 may be axially symmetric with the first branch electrode section 111C, in the plurality of first branch electrode sections 111, located between the second branch electrode section 121N and the third branch electrode section 131N that are adjacent to each other as an axis of symmetry.

In some implementations, the capacitor unit 1 may be a capacitor of an MOM structure. In addition, the first finger electrode 11, the second finger electrode 12, and the third finger electrode 13 of the capacitor unit 1 may be implemented by any quantity of metal layers, respectively. For example, when the first finger electrode 11 is implemented by three metal layers, layout patterns of the first finger electrode 11 on the metal layers may be substantially the same. Perpendicular projections of the layout patterns of the first finger electrode 11 on each metal layer may overlap one another. The layout patterns on each metal layer may be connected to one another through vias between the metal layers. Here, the vias may be provided at positions in correspondence to the first trunk electrode section 112 of the first finger electrode 11.

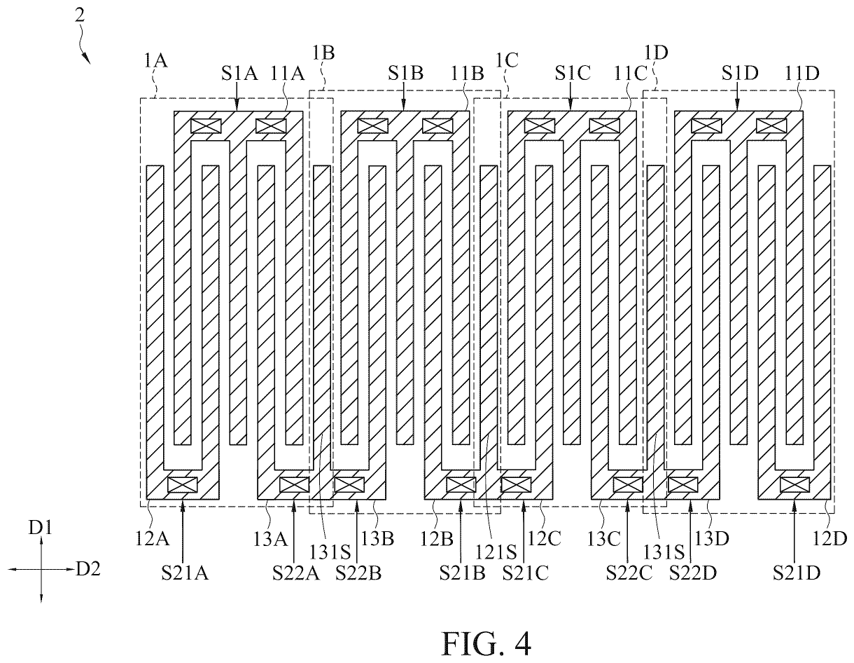

FIG. 4 is a schematic diagram of a layout of an embodiment of a capacitor. Refer to FIG. 1 to FIG. 4. In some embodiments, a capacitor 2 may include a plurality of capacitor units 1 of any embodiment. The following uses an example in which the capacitor 2 includes four capacitor units 1A to 1D. A quantity of capacitor units is not limited thereto. In addition, a layout pattern of the capacitor units 1A to 1D is, for example, a layout pattern shown in FIG. 1. However, this case is not limited thereto.

Refer to FIG. 4. In some embodiments, the capacitor units 1A to 1D may be disposed in sequence. Any two adjacent capacitor units in the capacitor units 1A to 1D abut each other through respective second finger electrodes by sharing one second branch electrode section 121S, or abut each other through respective third finger electrodes by sharing one third branch electrode section 131S. In addition, the shared second branch electrode section 121S and/or the shared third branch electrode section 131S extend/extends in the first direction D1.

In some embodiments, the capacitor units 1A to 1D may be disposed in a column in sequence in the second direction D2 orthogonal to the first direction D1. For example, a third finger electrode 13A of a capacitor unit 1A may abut a third finger electrode 13B of a capacitor unit 1B. That is, the third finger electrode 13A of the capacitor unit 1A and the third finger electrode 13B of the capacitor unit 1B may abut each other by sharing one third branch electrode section 131S. A second finger electrode 12B of the capacitor unit 1B may abut a second finger electrode 12C of a capacitor unit 1C. That is, the second finger electrode 12B of the capacitor unit 1B and the second finger electrode 12C of the capacitor unit 1C may abut each other by sharing one second branch electrode section 121S. A third finger electrode 13C of the capacitor unit 1C may abut a third finger electrode 13D of a capacitor unit 1D. That is, the third finger electrode 13C of the capacitor unit 1C and the third finger electrode 13D of the capacitor unit 1D may abut each other by sharing one third branch electrode section 131S. In this way, since the capacitor units 1A to 1D may abut one another by sharing the second branch electrode section 121S and/or sharing the third branch electrode section 131S, intervals specified by a layout rule are not required to be provided between the capacitor units 1A to 1D, to reduce a layout area of the capacitor 2.

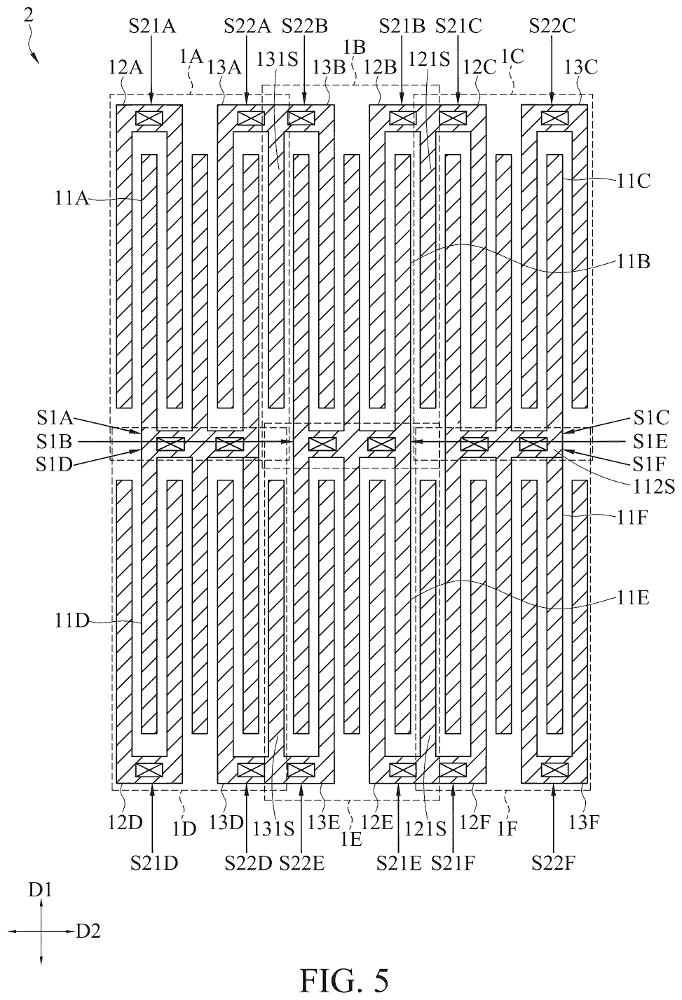

FIG. 5 is a schematic diagram of a layout of an embodiment of the capacitor. Refer to FIG. 5. In some embodiments, an example in which the capacitor 2 includes six capacitor units 1A to 1F is used for description. A layout pattern of the capacitor units 1A to 1F is, for example, a layout pattern shown in FIG. 1. However, this case is not limited thereto. The capacitor units 1A to 1F may be disposed in a matrix in sequence. Any two of the capacitor units 1A to 1F adjacent in the first direction D1 may abut each other through respective first finger electrodes by sharing a first trunk electrode section 112S. In addition, any two of the capacitor units 1A to 1F adjacent in the second direction D2 may abut each other through respective second finger electrodes by sharing one second branch electrode section 121S, or abut each other through respective third finger electrodes by sharing one third branch electrode section 131S. Here, the shared second branch electrode section 121S and/or the shared third branch electrode section 131S extend/extends in the first direction D1. The shared first trunk electrode section 112S extends in the second direction D2 orthogonal to the first direction D1.

For example, the capacitor units 1A to 1F may be disposed in a 2×1 matrix. The capacitor unit 1A, the capacitor unit 1B, and the capacitor unit 1C are disposed in a first column, and the capacitor unit 1D, a capacitor unit 1E, and the capacitor unit 1F are disposed in a second column. Here, the first direction D1 is a row direction of the matrix, and the second direction D2 is a column direction of the matrix. In the second direction D2, the capacitor unit 1A and the capacitor unit 1B that are located in the first column and adjacent to each other may abut each other through one third finger electrode 13A and one third finger electrode 13B by sharing one third branch electrode section 131S. The capacitor unit 1B and the capacitor unit 1C that are located in the first column and adjacent to each other may abut each other through one second finger electrode 12B and one second finger electrode 12C by sharing one second branch electrode section 121S. The capacitor unit 1D and the capacitor unit 1E that are located in the second column and adjacent to each other may abut each other through one third finger electrode 13D and a third finger electrode 13E by sharing one third branch electrode section 131S. The capacitor unit 1E and the capacitor unit 1F that are located in the second column and adjacent to each other may abut each other through one second finger electrode 12E and one second finger electrode 12F by sharing one second branch electrode section 121S. In addition, in the first direction D1, the capacitor unit 1A and the capacitor unit 1D that are located in a first row and adjacent to each other may abut each other through a first finger electrode 11A and a first finger electrode 11D by sharing one first trunk electrode section 112S. The capacitor unit 1B and the capacitor unit 1E that are located in a second row and adjacent to each other may abut each other through a first finger electrode 11B and a first finger electrode 11E by sharing one first trunk electrode section 112S. The capacitor unit 1C and the capacitor unit 1F that are located in a third row and adjacent to each other may abut each other through a first finger electrode 11C and a first finger electrode 11F by sharing one first trunk electrode section 112S. In this way, in addition to the capacitor units 1A to 1F sharing the second branch electrode section 121S and/or sharing the third branch electrode section 131S to avoid provision of intervals specified by a layout rule between the capacitor units 1A to 1F, the capacitor units 1A to 1F may share the first trunk electrode section 112S to further reduce a layout area of the capacitor 2.

In some embodiments, in the capacitor 2, first terminal signals S1A to S1F received by the first finger electrodes 11A to 11F of the capacitor units 1A to 1F may each be a positive terminal input signal, and second terminal signals S21A to S21F received by the second finger electrodes 12A to 12F of the capacitor units 1A to 1F and second terminal signals S22A to S22F received by the third finger electrodes 13A to 13F of the capacitor units 1A to 1F may each be a negative terminal input signal. In some other embodiments, the first terminal signals S1A to S1F received by the first finger electrodes 11A to 11F of the capacitor units 1A to 1F may each be a negative terminal input signal, and the second terminal signals S21A to S21F received by the second finger electrodes 12A to 12F of the capacitor units 1A to 1F and the second terminal signals S22A to S22F received by the third finger electrodes 13A to 13F of the capacitor units 1A to 1F may each be a positive terminal input signal.

In some embodiments, potentials of the first terminal signals S1A to S1F of the capacitor units 1A to 1F may be the same as one another. Potentials of the second terminal signals S21A to S21F of the capacitor units 1A to 1F may be the same as one another. Potentials of the second terminal signals S22A to S22F of the capacitor units 1A to 1F may be the same as one another. The potentials of the second terminal signals S21A to S21F are different from those of the second terminal signals S22A to S22F. In other words, the first terminal signals S1A to S1F may have only one potential, and the second terminal signals S21A to S21F and S22A to S22F may have two potentials. An example in which the capacitor 2 includes the four capacitor units 1A to 1D disposed in a column in sequence in the second direction D2 is used. In this case, as shown in FIG. 4, the second terminal signals S21A to S21D may be arranged interleaved with the second terminal signals S22A to S22D, to reduce mismatching effects.

In some other embodiments, potentials of the second terminal signals S21A to S21F of the capacitor units 1A to 1F may be the same as one another. Potentials of the second terminal signals S22A to S22F of the capacitor units 1A to 1F may be the same as one another. The potentials of the second terminal signals S21A to S21F are different from those of the second terminal signals S22A to S22F. In addition, a potential of a first terminal signal of at least one of the capacitor units 1A to 1F is different from that of a first terminal signal of another capacitor unit. In other words, the first terminal signals S1A to S1F may have at least two potentials, and the second terminal signals S21A to S21F and S22A to S22F may have two potentials. An example in which the capacitor 2 includes the four capacitor units 1A to 1D disposed in a column in sequence in the second direction D2 is used. In this case, as shown in FIG. 4, potentials of the first terminal signals S1B to S1D of the capacitor units 1B to 1D may be the same as one another, and a potential of the first terminal signal S1A of the capacitor unit 1A is different from that of the first terminal signals S1B to S1D of the capacitor units 1B to 1D. For another example, a potential of the first terminal signal S1A of the capacitor unit 1A may be the same as that of a first terminal signal S1C of the capacitor unit 1C and different from those of the first terminal signals S1B and S1D of the capacitor units 1B and 1D. This case is not limited thereto.

In some other embodiments, potentials of the first terminal signals S1A to S1F of the capacitor units 1A to 1F may be the same as one another. In a same capacitor unit, a potential of a second terminal signal is different from that of another second terminal signal. In addition, in the capacitor units 1A to 1F, potentials of two another second terminal signals of two adjacent capacitor units that abut each other by sharing the second branch electrode section 121S are different from each other, and potentials two second terminal signals of two adjacent capacitor units that abut each other by sharing the third branch electrode section 131S are different from each other. In other words, the first terminal signals S1A to S1F may have only one potential, and the second terminal signals S21A to S21F and S22A to S22F may have at least three potentials. An example in which the capacitor 2 includes the four capacitor units 1A to 1D disposed in a column in sequence in the second direction D2 is used. In this case, as shown in FIG. 4, a second terminal signal S21A may have a first potential, a second terminal signal S22A and a second terminal signal S22B may have a second potential, a second terminal signal S21B and a second terminal signal S21C may have a third potential, a second terminal signal S22C and a second terminal signal S22D may have a fourth potential, and a second terminal signal S21D may have a fifth potential. In some implementations, the first potential, the second potential, the third potential, the fourth potential, and the fifth potential may be different from one another. In some other implementations, the first potential may be the same as the fourth potential, the second potential may be the same as the fifth potential, and the first potential, the third potential, and the fifth potential may be different from one another.

In some other embodiments, in a same capacitor unit of the capacitor units 1A to 1F, a potential of a second terminal signal is different from that of another second terminal signal. In the capacitor units 1A to 1F, potentials of two another second terminal signals of two adjacent capacitor units that abut each other by sharing the second branch electrode section 121S are different from each other, and potentials two second terminal signals of two adjacent capacitor units that abut each other by sharing the third branch electrode section 131S are different from each other. In addition, a potential of a first terminal signal of at least one of the capacitor units 1A to 1F is different from that of a first terminal signal of another capacitor unit. In other words, the first terminal signals S1A to S1F may have at least two potentials, and the second terminal signals S21A to S21F and S22A to S22F may have three potentials.

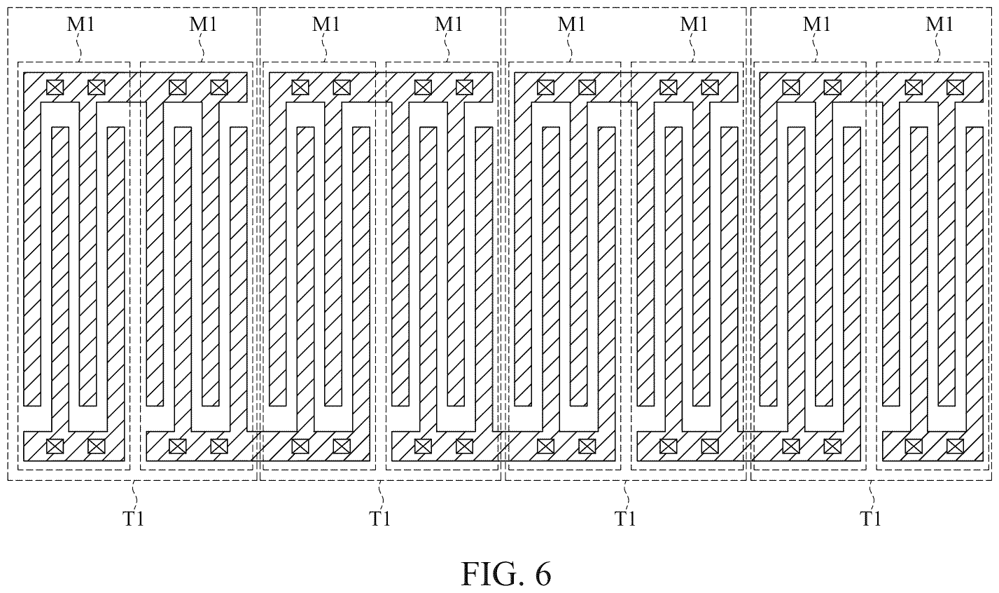

FIG. 6 is a schematic diagram of a layout of a capacitor implemented by a conventional MOM capacitor. Refer to FIG. 1 and FIG. 6. In some embodiments, a capacitance value of the capacitor unit 1 in an embodiment of this case shown in FIG. 1 may be the same as that of a capacitor unit T1 including two conventional MOM capacitors M1. However, comparison between the capacitor unit 1 shown in FIG. 1 and the capacitor unit T1 shown in FIG. 6 shows that the layout area of the capacitor unit 1 of this case is significantly smaller than that of the capacitor unit T1 including the two conventional MOM capacitors M1.

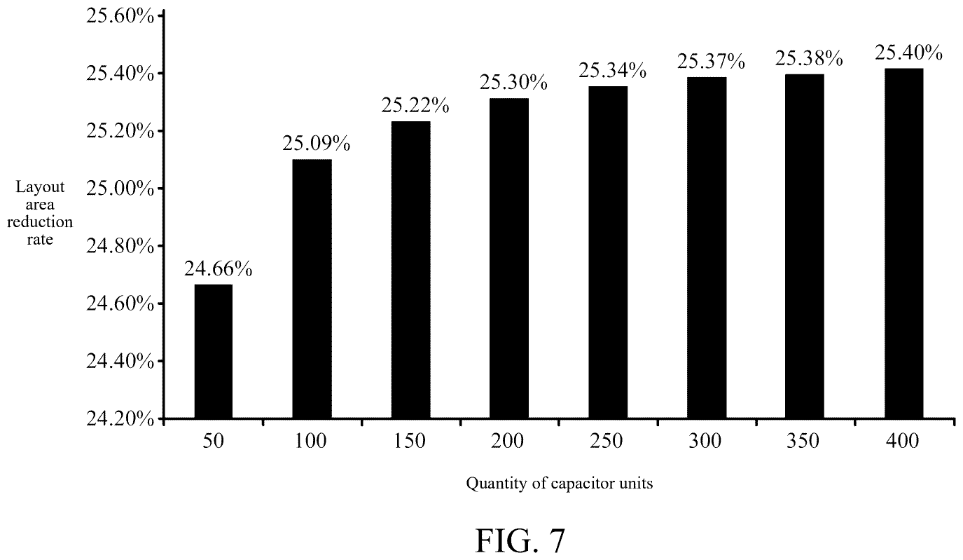

FIG. 7 is a histogram of a quantity of capacitor units and a layout area reduction rate. Refer to FIG. 7. Here, a horizontal coordinate is the quantity of capacitor units configured to implement the capacitor, and a longitudinal coordinate is the layout area reduction rate of the capacitor 2 implemented by the capacitor unit 1 of any embodiment of this case relative to the capacitor implemented by the conventional MOM capacitors M1. As shown in FIG. 7, as the quantity of capacitor units included in the capacitor increases, the layout area reduction rate of the capacitor 2 implemented by the capacitor unit 1 of any embodiment of this case relative to the capacitor implemented by the conventional MOM capacitors M1 may increase. Therefore, as an area of a wafer is reduced day by day, the capacitor 2 implemented by the capacitor unit 1 of any embodiment of this case may achieve, with a small layout area, a same capacitance value as that of the capacitor implemented by the conventional MOM capacitors M1.

In summary, for the capacitor 2 using the capacitor unit 1 of any embodiment, the layout area of the capacitor 2 can be reduced by sharing the second branch electrode section 121S, sharing the third branch electrode section 131S, and/or the first trunk electrode section 112S. In addition, the second terminal signals S21A to S21D and other second terminal signals S22A to S22D that are received by the capacitor 2 using the capacitor unit 1 of any embodiment may be arranged in an interleaving manner, to reduce the mismatching effects.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A capacitor unit, comprising:
a first finger electrode, configured to receive a first terminal signal;
a second finger electrode, pointing to the first finger electrode and configured to receive a second terminal signal; and
a third finger electrode, disposed adjacent to the second finger electrode with an interval, pointing to the first finger electrode, and configured to receive another second terminal signal,
wherein the first finger electrode points to the second finger electrode and the third finger electrode, one part of the first finger electrode is disposed interleaved with the second finger electrode, and the other part of the first finger electrode is disposed interleaved with the third finger electrode.

2. The capacitor unit according to claim 1, wherein the first terminal signal and the second terminal signal form a first set of differential signals, and the first terminal signal and the another second terminal signal form a second set of differential signals.

3. The capacitor unit according to claim 2, wherein the first terminal signal is a positive terminal input signal, and the second terminal signal and the another second terminal signal are negative terminal input signals different from each other, respectively.

4. The capacitor unit according to claim 2, wherein the first terminal signal is a negative terminal input signal, and the second terminal signal and the another second terminal signal are positive terminal input signals different from each other, respectively.

5. The capacitor unit according to claim 1, wherein the first finger electrode comprises a plurality of first branch electrode sections and a first trunk electrode section, the first branch electrode sections extend in a first direction and are arranged at intervals in a second direction, one end of each first branch electrode section is connected to the first trunk electrode section, and the first trunk electrode section is suitable to receive the first terminal signal; the second finger electrode comprises a plurality of second branch electrode sections and a second trunk electrode section, the second branch electrode sections extend in the first direction and are arranged at intervals in the second direction, one end of each second branch electrode section is connected to the second trunk electrode section, the other end of each second branch electrode section is adjacent to the first trunk electrode section and has a gap with the first trunk electrode section, and the second trunk electrode section is suitable to receive the second terminal signal; the third finger electrode comprises a plurality of third branch electrode sections and a third trunk electrode section, the third branch electrode sections extend in the first direction and are arranged at intervals in the second direction, one end of each third branch electrode section is connected to the third trunk electrode section, the other end of each third branch electrode section is adjacent to the first trunk electrode section and has a gap with the first trunk electrode section, and the third trunk electrode section is suitable to receive the another second terminal signal; and each first branch electrode section is located between two second branch electrode sections that are adjacent to each other, two third branch electrode sections that are adjacent to each other, or the second branch electrode section and the third branch electrode section that are adjacent to each other.

6. The capacitor unit according to claim 5, wherein a total quantity of the first branch electrode sections, the second branch electrode sections, and the third branch electrode sections is odd.

7. The capacitor unit according to claim 6, wherein in a case that a total quantity of the second branch electrode sections is the same as that of the third branch electrode sections, the second finger electrode and the third finger electrode are axially symmetric with the first branch electrode section located between the second branch electrode section and the third branch electrode section that are adjacent to each other as an axis of symmetry.

8. The capacitor unit according to claim 6, wherein a total quantity of the first branch electrode sections is a total quantity of the second branch electrode sections and the third branch electrode sections minus 1.

9. A capacitor, comprising:
a plurality of capacitor units according to claim 1, wherein the capacitor units are disposed in sequence, and any two adjacent capacitor units in the capacitor units abut each other through respective second finger electrodes by sharing one second branch electrode section, or abut each other through respective third finger electrodes by sharing one third branch electrode section.

10. The capacitor according to claim 9, wherein first terminal signals of the capacitor units are the same as one another, second terminal signals of the capacitor units are the same as one another, other second terminal signals of the capacitor units are the same as one another, and the second terminal signals are different from the other second terminal signals.

11. The capacitor according to claim 9, wherein first terminal signals of the capacitor units are the same as one another; in a same capacitor unit, a second terminal signal is different from another second terminal signal; and in the capacitor units, two another second terminal signals of two adjacent capacitor units that abut each other by sharing the second branch electrode section are different from each other, and two second terminal signals of two adjacent capacitor units that abut each other by sharing the third branch electrode section are different from each other.

12. The capacitor according to claim 9, wherein a first terminal signal of at least one of the capacitor units is different from that of another capacitor unit, second terminal signals of the capacitor units are the same as one another, other second terminal signals of the capacitor units are the same as one another, and the second terminal signals are different from the other second terminal signals.

13. The capacitor according to claim 9, wherein a first terminal signal of at least one of the capacitor units is different from that of another capacitor unit; in a same capacitor unit, a second terminal signal is different from another second terminal signal; and two another second terminal signals of two adjacent capacitor units that abut each other by sharing the second branch electrode section are different from each other, and two second terminal signals of two adjacent capacitor units that abut each other by sharing the third branch electrode section are different from each other.

14. The capacitor according to claim 9, wherein first terminal signals each are a positive terminal input signal, and second terminal signals and other second terminal signals each are a negative terminal input signal.

15. The capacitor according to claim 9, wherein first terminal signals each are a negative terminal input signal, and second terminal signals and other second terminal signals each are a positive terminal input signal.

16. The capacitor according to claim 9, wherein the shared second branch electrode section or the shared third branch electrode section extends in a first direction, and the capacitor units are disposed in a column in sequence in a second direction orthogonal to the first direction.

17. The capacitor according to claim 9, wherein the capacitor units are disposed in a matrix in sequence, any two of the capacitor units adjacent in a first direction abut each other through respective first finger electrodes by sharing one first trunk electrode section, and any two of the capacitor units adjacent in a second direction orthogonal to the first direction abut each other through respective second finger electrodes by sharing the second branch electrode section, or abut each other through respective third finger electrodes by sharing the third branch electrode section, wherein the shared second branch electrode section or the shared third branch electrode section extends in the first direction, and the shared first trunk electrode section extends in the second direction.

18. The capacitor according to claim 9, wherein the first finger electrode of each capacitor unit comprises a plurality of first branch electrode sections and a first trunk electrode section, the first branch electrode sections extend in a first direction and are arranged at intervals in a second direction, one end of each first branch electrode section is connected to the first trunk electrode section, and the first trunk electrode section is suitable to receive a first terminal signal; the second finger electrode of each capacitor unit comprises a plurality of second branch electrode sections and a second trunk electrode section, the second branch electrode sections extend in the first direction and are arranged at intervals in the second direction, one end of each second branch electrode section is connected to the second trunk electrode section, the other end of each second branch electrode section is adjacent to the first trunk electrode section and has a gap with the first trunk electrode section, and the second trunk electrode section is suitable to receive a second terminal signal; the third finger electrode of each capacitor unit comprises a plurality of third branch electrode sections and a third trunk electrode section, the third branch electrode sections extend in the first direction and are arranged at intervals in the second direction, one end of each third branch electrode section is connected to the third trunk electrode section, the other end of each third branch electrode section is adjacent to the first trunk electrode section and has a gap with the first trunk electrode section, and the third trunk electrode section is suitable to receive another second terminal signal; and each first branch electrode section of each capacitor unit is located between two second branch electrode sections that are adjacent to each other, two third branch electrode sections that are adjacent to each other, or the second branch electrode section and the third branch electrode section that are adjacent to each other.

19. The capacitor according to claim 18, wherein a total quantity of the first branch electrode sections, the second branch electrode sections, and the third branch electrode sections of each capacitor unit is odd.

20. The capacitor according to claim 18, wherein in each capacitor unit, a total quantity of the first branch electrode sections is a total quantity of the second branch electrode sections and the third branch electrode sections minus 1.
